(19) United States
(12) Patent Application Publication
(10) Pub. No.: US 2022/0388092 A1
(43) Pub. Date: Dec. 8, 2022

(54) METHODS FOR FORMING BONDING STRUCTURES

(71) Applicant: National Taiwan University, Taipei (TW)

(72) Inventors: Tung-Han CHUANG, Taipei (TW); Po-Ching WU, Taipei (TW); Pei-Ing LEE, Taipei (TW); Yu-Chang LAI, Taipei (TW); Hsing-Hua TSAI, Hsinchu City (TW); Chung-Hsin CHOU, Hsinchu City (TW)

(21) Appl. No.: 17/829,752

(22) Filed: Jun. 1, 2022

(30) Foreign Application Priority Data
Jun. 3, 2021 (TW) 110120126

(51) Int. Cl. B23K 20/233; B23K 20/02; B23K 20/16

(52) U.S. Cl. CPC B23K 20/233; B23K 20/02; B23K 20/16; B23K 2101/34

(57) ABSTRACT

A method for forming a bonding structure is provided, including providing a first metal, wherein the first metal has a first absolute melting point. The method includes forming a silver nano-twinned layer on the first metal. The silver nano-twinned layer includes parallel-arranged twin boundaries. The parallel-arranged twin boundaries include 90% or more [111] crystal orientation. The method includes oppositely bonding the silver nano-twinned layer to a second metal. The second metal has a second absolute melting point. The bonding of the silver nano-twinned layer and the second metal is performed at a temperature of 300° C. to half of the first absolute melting point or 300° C. to half of the second absolute melting point.

### CROSS-REFERENCE TO RELATED APPLICATIONS

The present application claims priority of Taiwan Application No. 110120126, filed on Jun. 3, 2021, which is incorporated by reference herein in its entirety.

### BACKGROUND

### Technical Field

The present disclosure relates to methods for forming bonding structures, and more particularly to methods for forming bonding structures using silver nano-twins.

### Description of the Related Art

Most conventional material bonding methods involve welding. Examples include arc welding, laser welding, electron beam welding, friction welding and other technologies. However, welding may have some problems. For example, cracks may be formed due to large deformations in the heat-affected zone when the material is being welded. Ceramic materials or high-temperature materials cannot be bonded. Pores may be formed, so that welding cannot be performed in a vacuum. Welding is slow and expensive. Only opposite bonding is practical, whereas face-to-face bonding is not feasible. Also, active metals are incapable of undergoing heterobonding.

A vacuum brazing bonding technology can make up for the shortcomings of welding methods and meet the needs of large-area bonding. However, the temperature of the bonded product will be limited by the melting point of the braze filler alloy.

A diffusion bonding technology works on the principle of solid-state diffusion and grain boundary motion of metal materials, so that the materials are naturally bonded below their melting point by pressure and heating. During the bonding process, the materials remain solid, so there is no problem with the limitation by the melting point of the braze filler alloy. In addition, the bonded workpieces are integrated into one piece, which means that the base materials can retain their characteristics.

However, in conventional diffusion bonding, the material needs to be heated to a temperature that is higher than half of its absolute melting point (0.5 Tm) to diffuse the material atoms at the bonding interface to achieve the purpose of diffusion bonding. The above-mentioned high temperature will cause material deterioration. Furthermore, in conventional diffusion bonding, the surface of the material needs to be very smooth and flat to ensure that the bonding interface is in close contact with each other. Therefore, the surface processing that is performed before bonding is more rigorous, and this can affect the production efficiency and capacity. In view of the various disadvantages of the conventional techniques, the bonding technology still has many challenges.

### SUMMARY

Some embodiments of the present disclosure provide a method for forming a bonding structure, including providing a first metal, wherein the first metal has a first absolute melting point. The method includes forming a silver nano-twinned layer on the first metal. The silver nano-twinned layer includes parallel-arranged twin boundaries. The parallel-arranged twin boundaries include 90% or more [111] crystal orientation. The method includes oppositely bonding the silver nano-twinned layer to a second metal. The second metal has a second absolute melting point. The bonding of the silver nano-twinned layer and the second metal is performed at a temperature of 300° C. to half of the first absolute melting point or 300° C. to half of the second absolute melting point.

In some embodiments of the present disclosure, at least 80% of the silver nano-twinned layer includes the parallel-arranged twin boundaries.

In some embodiments of the present disclosure, the distance between the parallel-arranged twin boundaries is between 1 nm and 100 nm.

In some embodiments of the present disclosure, the thickness of the silver nano-twinned layer is 0.1 μm to 100 μm.

In some embodiments of the present disclosure, forming the silver nano-twinned layer includes sputtering or evaporation coating.

In some embodiments of the present disclosure, the first metal is the same as the second metal.

In some embodiments of the present disclosure, the first metal is different from the second metal.

In some embodiments of the present disclosure, the first absolute melting point is higher than the second absolute melting point.

In some embodiments of the present disclosure, the first absolute melting point is lower than the second absolute melting point.

In some embodiments of the present disclosure, each of the first metal and the second metal includes: nickel (Ni), copper (Cu), silver (Ag), gold (Au), or a combination thereof.

In some embodiments of the present disclosure, the bonding of the silver nano-twinned layer to the second metal is performed under a pressure of 1 kg/mm² to 30 kg/mm².

In some embodiments of the present disclosure, a bonding time between the silver nano-twinned layer and the second metal is 0.5 to 1 hour, and the silver nano-twinned layer is formed as a grain layer without the parallel-arranged twin boundaries.

In some embodiments of the present disclosure, a bonding time between the silver nano-twinned layer and the second metal is 1 to 10 hours, and the silver nano-twinned layer is completely diffused into the first metal and the second metal, so that the first metal is formed as a first alloy layer and the second metal is formed as a second alloy layer.

In some embodiments of the present disclosure, the first alloy layer is in direct contact with the second alloy layer.

In some embodiments of the present disclosure, there is a transition grain layer between the first metal and the parallel-arranged twin boundaries.

In some embodiments of the present disclosure, an adhesive layer is formed between the first metal and the silver nano-twinned layer.

In some embodiments of the present disclosure, the thickness of the adhesive layer is 0.01 μm to 0.2 μm.

In some embodiments of the present disclosure, the adhesive layer includes titanium (Ti), chromium (Cr), titanium tungsten (TiW), or a combination thereof.

In some embodiments of the present disclosure, a bonding time between the silver nano-twinned layer and the second metal is 0.5 to 1 hour, and the silver nano-twinned layer and the adhesive layer are formed as a grain layer without the parallel-arranged twin boundaries.

In some embodiments of the present disclosure, a bonding time between the silver nano-twinned layer and the second metal is 1 to 10 hours, and the silver nano-twinned layer and the adhesive layer are completely diffused into the first metal and the second metal, so that the first metal is formed as a first alloy layer and the second metal is formed as a second alloy layer.

In some embodiments of the present disclosure, the first alloy layer is in direct contact with the second alloy layer.

In some embodiments of the present disclosure, forming the adhesive layer includes sputtering or evaporation coating.

### BRIEF DESCRIPTION OF THE DRAWINGS

Aspects of this disclosure are best understood from the following detailed description when read with the accompanying figures. It should be noted that, in accordance with common practice in the industry, various features are not drawn to scale. In fact, the dimensions of the various features may be arbitrarily increased or reduced for clarity of discussion.

FIGS. 1A-1D are schematic cross-sectional views of a bonding structure at various fabrication stages, where no adhesive layer is formed during the bonding process, according to some embodiments of the present disclosure.

FIGS. 2A-2C are schematic cross-sectional views of a bonding structure at various fabrication stages, where an adhesive layer is additionally formed during the bonding process, according to some embodiments of the present disclosure.

FIG. 3A is a focused ion beam (FIB) image of a titanium (Ti) adhesive layer and a silver nano-twinned layer formed on a nickel (100) single crystal surface, according to some embodiments of the present disclosure.

FIG. 3B is a focused ion beam (FIB) image of a silver nano-twinned layer formed on a nickel (100) single crystal surface, according to other embodiments of the present disclosure.

FIG. 4A is a focused ion beam (FIB) image of a titanium (Ti) adhesive layer and a silver nano-twinned layer formed on a copper (110) single crystal surface, according to some embodiments of the present disclosure.

FIG. 4B is a focused ion beam (FIB) image of a titanium (Ti) adhesive layer and a silver nano-twinned layer formed on a copper polycrystalline surface, according to other embodiments of the present disclosure.

FIG. 4C is a focused ion beam (FIB) image of a silver nano-twinned layer formed on a copper polycrystalline surface, according to other embodiments of the present disclosure.

### DETAILED DESCRIPTION

The following disclosure provides many different embodiments, or examples, for implementing different features of the subject matter provided. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features. In addition, the present disclosure may repeat reference numerals and/or letters in the various examples. This repetition is for the purpose of simplicity and clarity and does not in itself dictate a relationship between the various embodiments and/or configurations discussed.

Some variations of embodiments are described below. In different figures and illustrated embodiments, similar element symbols are used to indicate similar elements. It should be appreciated that additional operations can be provided before, during, and/or after the stages described in these embodiments. Some of the stages that are described can be replaced or eliminated for different embodiments.

Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Furthermore, when a number or a range of numbers is described with “about,” “approximate,” and the like, the term is intended to encompass numbers that are within a reasonable range including the number described, such as within +/— 10% of the number described or other values as understood by person skilled in the art. For example, the term “about 5 nm” encompasses the dimension range from 4.5 nm to 5.5 nm.

In addition, the use of ordinal terms such as “first”, “second”, “third”, etc., in the disclosure to modify an element does not by itself connote any priority, precedence, or order of one claim element over another or the temporal order in which it is formed, but are used merely as labels to distinguish one claim element having a certain name from another element having the same name (but for use of the ordinal term) to distinguish the claim elements.

Some embodiments of the present disclosure provide a method for forming a bonding structure, including conducting a bonding process using a silver nano-twinned layer. At least 80% of the silver nano-twinned layer includes parallel-arranged twin boundaries, and the parallel-arranged twin boundaries include 90% or more [111] crystal orientation. A diffusion bonding process can be performed at a low temperature ranging from 573K (300° C.) to half of the absolute melting point of the metal to be bonded because the characteristics of silver and twin structures make atoms have high diffusivity, which significantly reduces the temperature required for the diffusion bonding process to avoid material deterioration caused by high temperatures. Furthermore, an adhesive layer can be additionally formed on the metal surface in other embodiments of the present disclosure. The adhesive layer can improve the bonding force between the metal and silver nano-twinned layer to avoid peeling. Furthermore, the adhesive layer can reduce the influence of the crystal orientation of the metal on the silver nano-twinned layer.

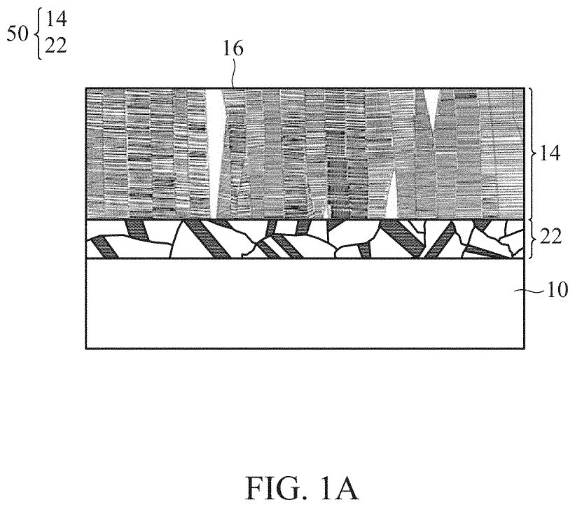

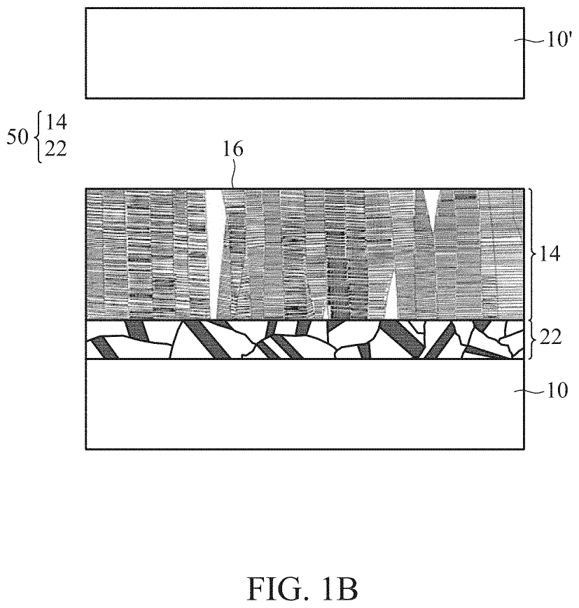

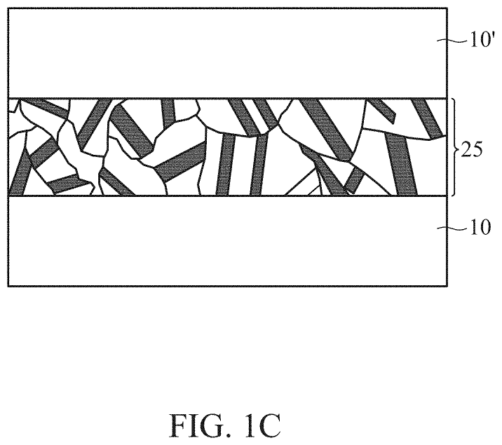

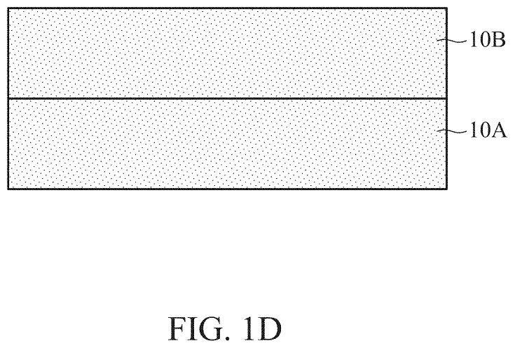

FIGS. 1A-1D are schematic cross-sectional views of a bonding structure at various fabrication stages, according to some embodiments of the present disclosure. Referring to FIG. 1A, a first metal 10 is provided. In some embodiments, the first metal may include, for example, nickel (Ni), copper (Cu), silver (Ag), gold (Au), or a combination thereof.

Still referring to FIG. 1A, a silver nano-twinned layer 50 is formed on the first metal 10. In some embodiments, the silver nano-twinned layer 50 includes nano-scale parallel-arranged twin boundaries (Σ3+Σ9) 14. In the cross-sectional view of the silver nano-twinned layer 50 combined with an analysis of electron backscatter diffraction (EBSD), the sum of twin boundaries (Σ3) and twin-like boundaries (Σ9) accounts for more than 40% of the overall grain boundaries. In addition, the parallel-arranged twin boundaries 14 include 90% or more [111] crystal orientation (such as greater than 90% or greater than 95%), and the distance between the parallel-arranged twin boundaries may be, for example, 1 nm to 100 nm, preferably 2 nm to 50 nm.

Still referring to FIG. 1A, in some embodiments, the thickness of the silver nano-twinned layer 50 is 0.1 μm to 100 μm, preferably 2 μm to 20 μm. The silver nano-twinned layer 50 includes parallel-stacked silver nano-twinned pillars 16. In some embodiments, the diameter of the silver nano-twinned pillars 16 may be 0.1 μm to 10 μm, preferably 0.3 μm to 1.0 μm.

Still referring to FIG. 1A, in some embodiments, in addition to the parallel-arranged twin boundaries 14, the silver nano-twinned layer 50 also includes a transition grain layer 22. When the silver nano-twinned layer 50 is initially formed on the first metal 10, instead of the parallel-arranged twin boundaries 14, the transitional grain layer 22 without the parallel-arranged twin boundaries 14 will be formed first. In some embodiments, the thickness of the transition grain layer 22 may be, for example, 0.1 μm to about 1 μm.

In some embodiments, the silver nano-twinned layer 50 may be formed on the first metal 10 through sputtering. In some embodiments, the sputtering process may use single sputtering gun or multiple sputtering guns. In the sputtering process, the power source may be DC, DC plus, RF, or high-power impulse magnetron sputtering (HIPIMS). The power for sputtering the silver nano-twinned layer 50 may be, for example, about 100 W to about 500 W. The sputtering process is performed at room temperature; however, the temperature during the sputtering process may rise by about 50° C. to about 200° C. The background pressure of the sputtering process may be less than 1×10⁻⁵ torr, and the working pressure may be, for example, about 1×10⁻³ torr to 1×10⁻² torr. The flow rate of argon may be about 10 sccm to about 20 sccm. The rotation speed of the stage may be, for example, about 5 rpm to about 20 rpm. During the sputtering process, a bias voltage of about −100V to about −200V is applied to the substrate. The deposition rate of the silver nano-twinned layer 50 may be, for example, about 0.5 nm/s to about 3 nm/s. It should be understood that the parameters of the sputtering process described above may be appropriately adjusted according to practical applications, and are not intended to be limited.

In other embodiments, the silver nano-twinned layer 50 may be formed on the first metal 10 through evaporation coating. In some embodiments, the background pressure of the evaporation coating process may be less than 1×10⁻⁵ torr, and the working pressure may be, for example, about 1×10⁻⁴ torr to 5×10⁻⁴ torr. The flow rate of argon may be about 2 sccm to about 10 sccm. The rotation speed of the stage may be, for example, about 5 rpm to about 20 rpm. The deposition rate of the silver nano-twinned layer 50 may be, for example, about 1 nm/s to about 5.0 nm/s. Additionally, an ion bombardment may be applied to the silver nano-twinned layer 50 with a voltage of about 10 V to about 300 V and a current of about 0.1 A to about 1.0 A during the evaporation coating process. It should be understood that the parameters of the evaporation coating process described above may be appropriately adjusted according to practical applications, and are not intended to be limited.

In conventional technology, nanotwins are formed through an electroplating process, compared with sputtering or evaporation coating process, sizes of components or contacts formed through the electroplating process may be limited. In particular, components or contacts generally smaller than 2 μm cannot be produced through the electroplating process. In contrast, components or contacts with sizes below 2 μm can be easily manufactured by sputtering or evaporation coating process.

The formation of twins is due to the accumulated strain energy inside a material. The strain energy drives uniform atomic shear to unsheared atoms at some regions inside the grain to form lattice positions that are mirror-symmetrical to each other. Twins include annealing twins and mechanical twins. The mutually symmetrical interface is the twin boundary.

Twins are mainly formed in face centered cubic (FCC) or hexagonal closed-packed (HCP) crystalline materials with the closest lattice arrangement. In addition to the crystal structure with the closest lattice arrangement, twins are more likely formed in materials with small stacking fault energy. For example, aluminum is a FCC crystal material, but its stacking fault energy is about 200 erg/cm′. Therefore, twins are rarely formed in aluminum.

Twin boundaries are coherent crystal structures and are classified as Σ3 and Σ9 special grain boundaries with low interfacial energy. The crystal orientations are all {111}. Compared with high-angle grain boundaries formed by general annealing and recrystallization, the interfacial energy of twin boundaries is about 5% of the interfacial energy of high-angle grain boundaries (George E. Dieter, Mechanical Metallurgy, McGRAW-HILL Book Company, 1976, P. 135-141).

Due to the low interfacial energy of the twin boundaries, oxidation, sulfurization, and chloride ion corrosion may be avoided. Therefore, the silver nano-twinned thin film exhibits better resistance to oxidation and corrosion. In addition, the symmetrical lattice arrangement of twins is less likely to impede electron transportation. Therefore, the silver nano-twinned thin film exhibits better electrical and thermal conductivity. Because the twin boundaries inhibit the movement of dislocation, materials may still maintain high tensile strength. The characteristics of high tensile strength and electrical conductivity have been proven in the copper thin film. See Ultrahigh Strength and High Electrical Conductivity in Copper, Science, vol. 304, 2004, p. 422-426 issued to L. Lu, Y. Shen, X. Chen, L. Qian, and K. Lu.

In an aspect of high-temperature stability, twin boundaries are more stable than high-angle grain boundaries due to the low interfacial energy of twin boundaries. Twin boundaries are less likely to move at high temperatures. Twin boundaries may have an effect on locking surrounding high-angle grain boundaries, making the high-angle grain boundaries unable to move. Therefore, the grains may not grow significantly at high temperatures, which enable the tensile strength of the material to be maintained at high temperatures.

In an aspect of current reliability, since atoms have a low diffusion rate when passing through twin boundaries with low interfacial energy, it is difficult to move atoms inside the wire at a high current density during operation of electronic devices. As such, the electromigration that often occurs when current passes through a wire is inhibited. It has been proven that twins can inhibit electromigration in copper thin film. See Observation of Atomic Diffusion at Twin-Modified Grain Boundaries in Copper, Science, vol. 321, 2008, p. 1066-1069 issued to K. C. Chen, W. W. Wu, C. N. Liao, L. J. Chen, and K. N. Tu.

Referring to FIG. 1B, a second metal 10′ is provided. In some embodiments, the second metal may include, for example, nickel (Ni), copper (Cu), silver (Ag), gold (Au), or a combination thereof. In some embodiments, the first metal 10 is the same as the second metal 10′. In other embodiments, the first metal 10 is different from the second metal 10′. Then, oppositely bonding the silver nano-twinned layer 50 and the second metal 10′. The first metal 10 has a first absolute melting point (Tₘ₁), and the second metal 10′ has a second absolute melting point (Tₘ₂). In some embodiments, the first absolute melting point may be higher than the second absolute melting point. In other embodiments, the first absolute melting point may be lower than the second absolute melting point. In some embodiments, the bonding of the silver nano-twinned layer 50 and the second metal 10′ may be performed at a temperature of 300° C. (573K) to half of the first absolute melting point (0.5 Tₘ₁) and under a pressure of 1 kg/mm² to 30 kg/mm². In other embodiments, the bonding of the silver nano-twinned layer 50 and the second metal 10′ may be performed at a temperature of 300° C. (573K) to half of the second absolute melting point (0.5 Tₘ₂) and under a pressure of 1 kg/mm² to 30 kg/mm².

In the embodiment where the first metal 10 is copper and the second metal 10′ is copper, the bonding of the silver nano-twinned layer 50 and the second metal 10′ can be performed at a temperature of 300° C. to 400° C. and under a pressure of 1 kg/mm² to 10 kg/mm². In the embodiment where the first metal 10 is nickel and the second metal 10′ is nickel, the bonding of the silver nano-twinned layer 50 and the second metal 10′ can be performed at a temperature of 400° C. to 550° C. and under a pressure of 5 kg/mm² to 30 kg/mm². In the embodiment where the first metal 10 is copper and the second metal 10′ is nickel, the bonding of the silver nano-twinned layer 50 and the second metal 10′ can be performed at a temperature of 300° C. to 400° C. and under a pressure of 5 kg/mm² to 30 kg/mm².

The materials of the first metal and the second metal may be the same or different and may each be metals to be bonded on a semiconductor wafer (e.g., pads, bumps, pillars, etc.). The first metal and the second metal may also each be metal layers on a semiconductor substrate, a ceramic substrate, a printed circuit board (PCB), or the like.

Since the [111] crystal orientation of silver nanotwins has a high diffusion rate, the present disclosure can conduct the bonding process at a lower temperature than that of the conventional bonding process, so as to avoid material deterioration caused by high temperature. In addition, the present disclosure uses a pressure range of 1 kg/mm² to 30 kg/mm², so that both metal and silver nanotwins can remain intact. Although the bonding process can be performed at a low pressure in conventional technique, it is necessary to perform chemical mechanical polishing (CMP) on the nano-twinned film before bonding to reduce the surface roughness. It not only complicates the process but also has potential risk to damage the nano-twinned film. Compared with conventional technique, the present disclosure applies a pressure of 1 kg/mm² to 30 kg/mm² so that protrusions on the surface of the silver nanotwins may undergo a nano-scale shaping to achieve the effect of close contact with the target. It not only solves the problem of surface roughness of silver nanotwins, but also eliminates the need for additional chemical mechanical polishing or other surface treatment in conventional technique, which can substantially increase throughput and yield.

The silver nanotwins of the present disclosure (Hardness is about 2 GPa.) are softer than the conventional copper nanotwins (Hardness is about 4 GPa.). That is, the hardness of the conventional copper nanotwins is about twice that of the silver nanotwins of the present disclosure. If the protrusions shaping mechanism described above is applied to solve the problem of surface roughness of copper nanotwins, it will be necessary to apply a pressure of more than 100 MPa, which will damage the copper nanotwins. Furthermore, since silver nanotwins are softer than copper nanotwins and are not easily oxidized, the influence of surface roughness in subsequent bonding process with other materials is reduced, so that a better bonding interface can be obtained.

In addition, the resistivity of silver is 1.63 μΩ·cm, which is lower than that of copper (1.69μΩ·cm), gold (2.2μΩ·cm), and nickel (6.90μΩ·cm). The stacking fault energy of silver is 25 mJ/m², which is also lower than that of copper (70 mJ/m²), gold (45 mJ/m²), and nickel (225 mJ/m²). Therefore, silver is more likely to form twins than copper, gold and nickel.

Referring to FIG. 1C, in some embodiments, a bonding time between the silver nano-twinned layer 50 and the second metal 10′ is 0.5 to 1 hour, and the silver nano-twinned layer 50 is formed as a grain layer 25 with ordinary grains. In other words, the grain layer 25 does not include the parallel-arranged twin boundaries. When the bonding time is 0.5 to 1 hour, the base material will not recrystallize, and the original mechanical strength can be maintained.

Referring to FIG. 1D, in other embodiments, a bonding time between the silver nano-twinned layer 50 and the second metal 10′ is 1 to 10 hours, the silver nano-twinned layer 50 is completely diffused into the first metal 10 and the second metal 10′, so that the first metal 10 is formed as a first alloy layer 10A and the second metal 10′ is formed as a second alloy layer 10B. The first alloy layer 10A is in direct contact with the second alloy layer 10B. When the bonding time is 1 to 10 hours, the silver nano-twinned layer is solid-fused into the base material. The bonding interface completely disappears, and a mechanical strength close to that of the base material can be obtained. In some embodiments, the mechanical strength of the base material can be adjusted additionally by recrystallization of the base material.

In semiconductor devices, the bonding structure can be used as, for example, pillar, wire, or solder, etc. Compared with the conventional bonding method, the embodiments of the present disclosure have advantages in using silver nanotwins for the bonding process. As described above, silver has lower resistivity, stacking fault energy and melting point. It is easier to form nanotwins and can be used in a low temperature and low pressure bonding process.

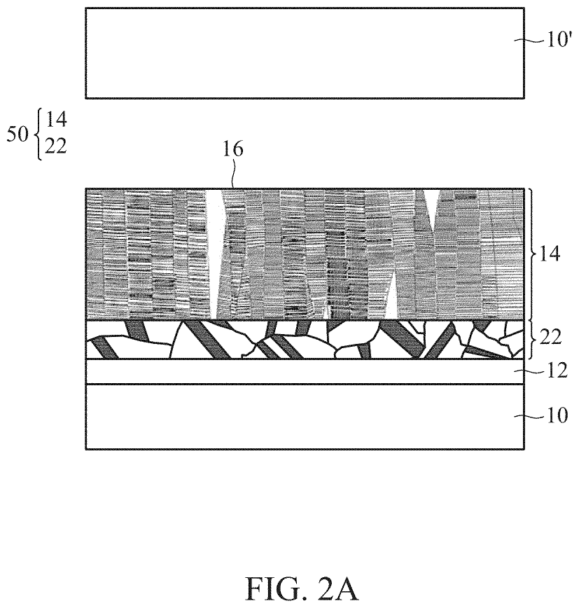

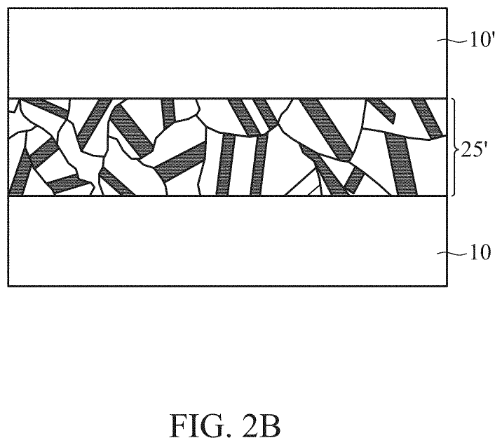

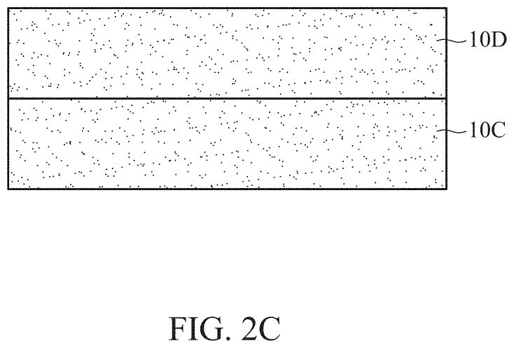

FIGS. 2A-2C are schematic cross-sectional views of a bonding structure at various fabrication stages, according to other embodiments of the present disclosure. Compared with the embodiments shown in FIGS. 1A-1D, an adhesive layer is additionally formed on the metal surface before the formation of the silver nano-twinned layer in the embodiments shown in FIGS. 2A-2C. The adhesive layer can improve the bonding force between the metal and silver nano-twinned layer to avoid peeling, and the adhesive layer can reduce the influence of the crystal orientation of the metal on the silver nano-twinned layer.

Referring to FIG. 2A, the first metal 10 and the second metal 10′ are provided. For the materials of the first metal 10 and the second metal 10′, reference may be made to the embodiment shown in FIG. 1B. Thus, it is not repeated again.

Still referring to FIG. 2A, an adhesive layer 12 may be formed on the first metal 10. In some embodiments, the adhesive layer 12 includes titanium (Ti), chromium (Cr), titanium tungsten (TiW), or a combination thereof. The adhesive layer can provide a better bonding force between the first metal 10 and the silver nano-twinned layer 50 formed subsequently, and has the effect of lattice buffering. The thickness of the adhesive layer 12 may be 0.01 μm to 0.2 μm, such as 0.05 μm to 0.1 μm.

In some embodiments, the adhesive layer 12 may be formed on the first metal 10 through sputtering. The sputtering process may use a single sputtering gun or multiple sputtering guns. In the sputtering process, the power source may be DC, DC plus, RF, or high-power impulse magnetron sputtering (HIPIMS). The power for sputtering the adhesive layer 12 may be, for example, about 100 W to about 500 W. The sputtering process is performed at room temperature; however, the temperature during the sputtering process may rise by about 50° C. to about 200° C. The background pressure of the sputtering process may be less than 1×10⁻⁵ torr, and the working pressure may be, for example, about 1×10⁻³ torr to 1×10⁻² torr. The flow rate of argon may be about 10 sccm to about 20 sccm. The rotation speed of the stage may be, for example, about 5 rpm to about 20 rpm. During the sputtering process, a bias voltage of about −100V to about −200V is applied to the substrate. The deposition rate of the adhesive layer 12 may be, for example, about 0.5 nm/s to about 3 nm/s. It should be understood that the parameters of the sputtering process described above may be adjusted appropriately according to practical applications, and are not intended to be limited.

In other embodiments, the adhesive layer 12 may be formed on the first metal 10 through evaporation coating. The background pressure of the evaporation coating process may be less than 1×10⁻⁵ torr, and the working pressure may be, for example, about 1×10⁻⁴ torr to 5×10⁻⁴ torr. The flow rate of argon may be about 2 sccm to about 10 sccm. The rotation speed of the stage may be, for example, about 5 rpm to about 20 rpm. The deposition rate of the adhesive layer 12 may be, for example, about 1 nm/s to about 5.0 nm/s. It should be understood that the parameters of the evaporation coating process described above may be appropriately adjusted according to practical applications, and are not intended to be limited.

In practice, when the thickness of the nano-twinned film is greater than 2 the bonding force between the nano-twinned film and the metal has deteriorated significantly, and the nano-twinned film can be peeled off easily. The nano-twinned film less than 2 μm in thickness will quickly and completely react with the bonding material in subsequent bonding process, which is not useful in practical applications. In the present disclosure, the adhesive layer is formed on the surface of the metal before the formation of the nano-twinned layer, which can help ensure that the nano-twinned layer is thicker than 10 as well as ensuring the good bonding force between the nano-twinned layer and the metal. Furthermore, the adhesive layer has the lattice buffering effect on forming the twin structure on the metal with different crystal orientation. In particular, regardless of the crystal orientation of the metal, the nanotwins formed on the metal still include greater than 90% of the [111] crystal orientation.

Still referring to FIG. 2A, the silver nano-twinned layer 50 may be formed on the adhesive layer 12. For the structure and formation of the silver nano-twinned layer 50, reference may be made to the embodiment shown in FIG. 1A. Thus, it is not repeated again.

Then, oppositely bonding the silver nano-twinned layer 50 and the second metal 10′. The first metal 10 has the first absolute melting point (Tₘ₁), and the second metal 10′ has the second absolute melting point (Tₘ₂). In some embodiments, the first absolute melting point may be higher than the second absolute melting point. In other embodiments, the first absolute melting point may be lower than the second absolute melting point. In some embodiments, the bonding of the silver nano-twinned layer 50 and the second metal 10′ may be performed at a temperature of 300° C. (573K) to half of the first absolute melting point (0.5 Tₘ₁) and under a pressure of 1 kg/mm² to 30 kg/mm². In other embodiments, the bonding of the silver nano-twinned layer 50 and the second metal 10′ may be performed at a temperature of 300° C. (573K) to half of the second absolute melting point (0.5 Tₘ₂) and under a pressure of 1 kg/mm² to 30 kg/mm².

In the embodiment where the first metal 10 is copper and the second metal 10′ is copper, the bonding of the silver nano-twinned layer 50 and the second metal 10′ can be performed at a temperature of 300° C. to 400° C. and under a pressure of 1 kg/mm² to 10 kg/mm². In the embodiment where the first metal 10 is nickel and the second metal 10′ is nickel, the bonding of the silver nano-twinned layer 50 and the second metal 10′ can be performed at a temperature of 400° C. to 550° C. and under a pressure of 5 kg/mm² to 30 kg/mm². In the embodiment where the first metal 10 is copper and the second metal 10′ is nickel, the bonding of the silver nano-twinned layer 50 and the second metal 10′ can be performed at a temperature of 300° C. to 400° C. and under a pressure of 5 kg/mm² to 30 kg/mm².

Referring to FIG. 2B, in some embodiments, a bonding time between the silver nano-twinned layer 50 and the second metal 10′ is 0.5 to 1 hour, and the adhesive layer 12 and silver nano-twinned layer 50 are formed as a grain layer 25′ with ordinary grains. In other words, the grain layer 25′ does not include the parallel-arranged twin boundaries. When the bonding time is 0.5 to 1 hour, the base material will not recrystallize, and the original mechanical strength can be maintained.

Referring to FIG. 2C, in other embodiments, a bonding time between the silver nano-twinned layer 50 and the second metal 10′ is 1 to 10 hours, the adhesive layer 12 and silver nano-twinned layer 50 are completely diffused into the first metal 10 and the second metal 10′, so that the first metal 10 is formed as a third alloy layer 10C and the second metal 10′ is formed as a fourth alloy layer 10D. The third alloy layer 10C is in direct contact with the fourth alloy layer 10D. When the bonding time is 1 to 10 hours, the silver nano-twinned layer is solid-fused into the base material. The bonding interface completely disappears, and a mechanical strength close to that of the base material can be obtained. In some embodiments, the mechanical strength of the base material can be adjusted additionally by recrystallization of the base material.

The following describes some examples of the present disclosure for forming bonding structures.

### Example 1

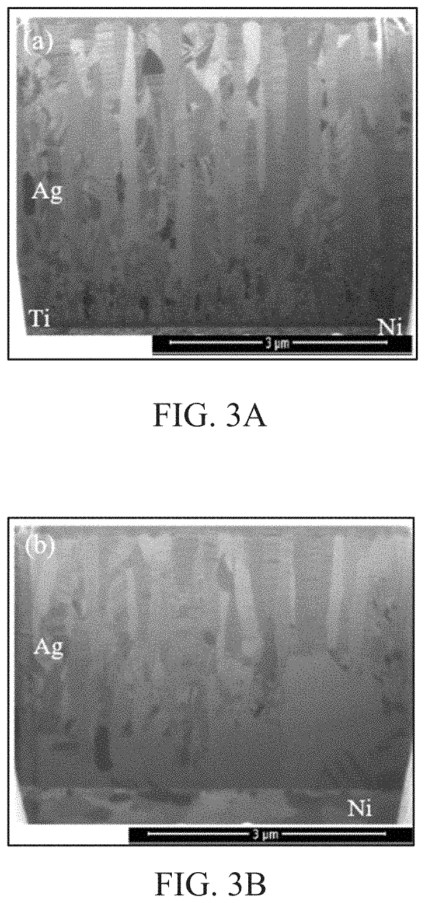

Referring to FIG. 3A, by using sputtering process, a titanium adhesive layer was formed to a thickness of 0.1 μm on a surface of nickel (100) single crystal, and then a silver nano-twinned layer was formed to a thickness of 4 μm on the titanium adhesive layer. After stacking the silver nano-twinned layer and nickel (100) single crystal, heating for 30 minutes under the condition of vacuum degree of 10⁻⁵ torr, pressure of 10 kg/mm² and temperature of 500° C. to complete the bonding process.

### Example 2

Referring to FIG. 3B, by using sputtering process, a silver nano-twinned layer was formed to a thickness of 3 μm on a surface of nickel (100) single crystal. After stacking the silver nano-twinned layer and nickel (100) single crystal, heating for 30 minutes under the condition of vacuum degree of 10⁻⁵ torr, pressure of 10 kg/mm² and temperature of 500° C. to complete the bonding process.

### Example 3

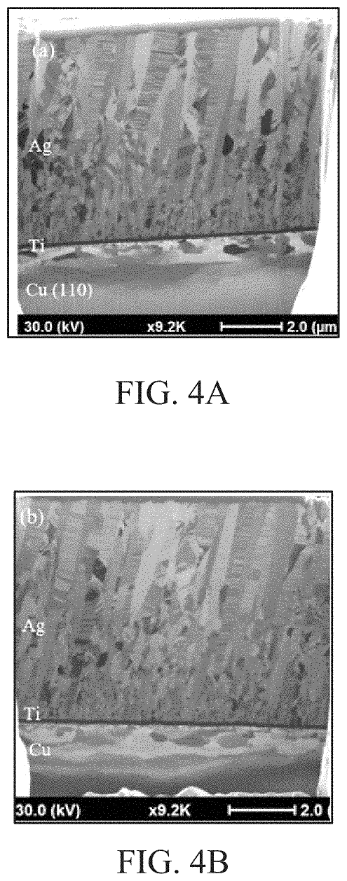

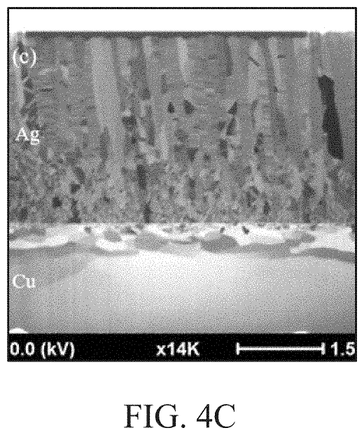

Referring to FIG. 4A, by using sputtering process, a titanium adhesive layer was formed to a thickness of 0.1 μm on a surface of copper (110) single crystal, and then a silver nano-twinned layer was formed to a thickness of 8 μm on the titanium adhesive layer. After stacking the silver nano-twinned layer and copper (110) single crystal, heating for 30 minutes under the condition of vacuum degree of 10⁻⁵ torr, pressure of 10 kg/mm² and temperature of 400° C. to complete the bonding process.

### Example 4

Referring to FIG. 4B, by using sputtering process, a titanium adhesive layer was formed to a thickness of 0.1 μm on a surface of copper polycrystalline, and then a silver nano-twinned layer was formed to a thickness of 8 μm on the titanium adhesive layer. After stacking the silver nano-twinned layer and copper polycrystalline, heating for 30 minutes under the condition of vacuum degree of 10⁻⁵ torr, pressure of 10 kg/mm² and temperature of 400° C. to complete the bonding process.

### Example 5

Referring to FIG. 4C, by using sputtering process, a silver nano-twinned layer was formed to a thickness of 4 μm on a surface of copper polycrystalline. After stacking the silver nano-twinned layer and copper polycrystalline, heating for 30 minutes under the condition of vacuum degree of 10⁻⁵ torr, pressure of 10 kg/mm² and temperature of 400° C. to complete the bonding process.

Some embodiments of the present disclosure have some advantageous, including conducting the diffusion bonding process using the silver nano-twinned layer. At least 80% of the silver nano-twinned layer includes the parallel-arranged twin boundaries, and the parallel-arranged twin boundaries include 90% or more [111] crystal orientation. Furthermore, silver has lower resistivity, lower stacking fault energy, and a lower melting point. It is easier when forming a nano-twinned structure and can be used in a low-temperature and low-pressure bonding process, which reduces the temperature required for the diffusion bonding process to avoid material deterioration caused by high temperatures, thereby improving product reliability. Furthermore, the adhesive layer can improve the bonding force between the metal and the silver nano-twinned layer to avoid peeling, and the adhesive layer can reduce the influence of the crystal orientation of the metal on the silver nano-twinned layer.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A method for forming a bonding structure, comprising:
providing a first metal, wherein the first metal has a first absolute melting point;
forming a silver nano-twinned layer on the first metal, wherein the silver nano-twinned layer includes parallel-arranged twin boundaries and the parallel-arranged twin boundaries include 90% or more [111] crystal orientation; and
oppositely bonding the silver nano-twinned layer and a second metal, wherein the second metal has a second absolute melting point and the bonding of the silver nano-twinned layer and the second metal is performed at a temperature of 300° C. to half of the first absolute melting point or 300° C. to half of the second absolute melting point.

2. The method for forming the bonding structure as claimed in claim 1, wherein at least 80% of the silver nano-twinned layer comprises the parallel-arranged twin boundaries.

3. The method for forming the bonding structure as claimed in claim 1, wherein a distance between the parallel-arranged twin boundaries is between 1 nm and 100 nm.

4. The method for forming the bonding structure as claimed in claim 1, wherein a thickness of the silver nano-twinned layer is 0.1 μm to 100 μm.

5. The method for forming the bonding structure as claimed in claim 1, wherein forming the silver nano-twinned layer comprises sputtering or evaporation coating.

6. The method for forming the bonding structure as claimed in claim 1, wherein the first metal is the same as the second metal.

7. The method for forming the bonding structure as claimed in claim 1, wherein the first metal is different from the second metal.

8. The method for forming the bonding structure as claimed in claim 7, wherein the first absolute melting point is higher than the second absolute melting point.

9. The method for forming the bonding structure as claimed in claim 7, wherein the first absolute melting point is lower than the second absolute melting point.

10. The method for forming the bonding structure as claimed in claim 1, wherein each of the first metal and the second metal comprises: nickel (Ni), copper (Cu), silver (Ag), gold (Au), or a combination thereof.

11. The method for forming the bonding structure as claimed in claim 1, wherein the bonding of the silver nano-twinned layer and the second metal is performed under a pressure of 1 kg/mm² to 30 kg/mm².

12. The method for forming the bonding structure as claimed in claim 1, wherein a bonding time between the silver nano-twinned layer and the second metal is 0.5 to 1 hour, and the silver nano-twinned layer is formed as a grain layer without the parallel-arranged twin boundaries.

13. The method for forming the bonding structure as claimed in claim 1, wherein a bonding time between the silver nano-twinned layer and the second metal is 1 to 10 hours, and the silver nano-twinned layer is completely diffused into the first metal and the second metal, so that the first metal is formed as a first alloy layer and the second metal is formed as a second alloy layer.

14. The method for forming the bonding structure as claimed in claim 13, wherein the first alloy layer is in direct contact with the second alloy layer.

15. The method for forming the bonding structure as claimed in claim 1, further comprising a transition grain layer between the first metal and the parallel-arranged twin boundaries.

16. The method for forming the bonding structure as claimed in claim 15, further comprising forming an adhesive layer between the first metal and the silver nano-twinned layer.

17. The method for forming the bonding structure as claimed in claim 16, wherein a thickness of the adhesive layer is 0.01 μm to 0.2 μm.

18. The method for forming the bonding structure as claimed in claim 16, wherein the adhesive layer comprises titanium (Ti), chromium (Cr), titanium tungsten (TiW), or a combination thereof.

19. The method for forming the bonding structure as claimed in claim 16, wherein forming the adhesive layer comprises sputtering or evaporation coating.
